(19) United States
(12) Patent Application Publication
(10) Pub. No.: US 2024/0177124 A1
(43) Pub. Date: May 30, 2024

(54) Methods and Systems for Improved Security During Transfer of Cryptocurrency and NFTs in a Trust or Estate using Live-ID

(71) Applicant: Clocr Inc., Austin, TX (US)

(72) Inventor: Sreekanth Chintala, Austin, TX (US)

(21) Appl. No.: 18/478,917

(22) Filed: Sep. 29, 2023

Related U.S. Application Data
(63) Continuation-in-part of application No. PCT/US23/75438, filed on Sep. 25, 2023.
(60) Provisional application No. 63/411,071, filed on Sep. 28, 2022.
(60) Provisional application No. 63/411,077, filed on Sep. 28, 2022.
(60) Provisional application No. 63/411,078, filed on Sep. 28, 2022.
(60) Provisional application No. 63/411,080, filed on Sep. 28, 2022.

(51) Int. Cl. G06Q 20/10; G06Q 20/36; G06Q 20/38; G06Q 20/40; G06Q 20/42

(52) U.S. Cl. CPC G06Q 20/10; G06Q 20/367; G06Q 20/38215; G06Q 20/3829; G06Q 20/40145; G06Q 20/42; G06Q 2220/00

(57) ABSTRACT

Systems and methods for more securely distributing digital assets, cryptocurrency and NFTs are described. The systems and methods as described facilitate the validation and transfer of cryptocurrency, non-fungible tokens (NFTs) and the like, at the behest of or upon the death of an owner.

### TECHNICAL FIELD

The disclosure relates generally to digital asset management and, more particularly, to methods and systems for improving security surrounding the dispensation of digital assets by improving the manner in which digital assets are, validated and transferred, including for example, cryptocurrency, non-fungible tokens (NFTs) and other digital currencies, at the behest of or upon the death of an owner. More particularly, the methods and systems as described relate to the use of LIVE-ID in the allocation of one's assets to transfer upon the occurrence of a denominated life event, including death, validation of the happening of that event, post-event asset authentication and collection, and finally, asset transfer. The systems and methods as described are effective for safely transferring currency and other assets that exist in a digital form and which, like physical money, are often unrecoverable after transfer.

### BACKGROUND

As the world moves from paper transactions to digital transactions and as new and exciting forms of currency are developed, the handling, storage, security, access, and transfer of all digital assets, particularly valuable assets, has fundamentally changed. Ordinary people have begun to invest in new and exciting digital assets including cryptocurrencies and non-fungible tokens (NFTs). As our world continues to see digital evolution, new and different digital assets will likely be developed. These assets are valued property and the systems and methods as described herein provide secure solutions to the transfer of those assets at the behest of the owner or after the owner's death.

Cryptocurrency is digital currency backed by a secure network, called a blockchain. A blockchain is recognized to be a peer-to-peer, electronic ledger which is implemented as a computer-based decentralized, distributed computer-implemented system made up of blocks which, in turn, are made up of transactions. Each transaction is a data structure that encodes the transfer of control of a digital asset between participants in the blockchain computer-implemented system and includes at least one input and at least one output. Each block contains a hash of the previous block so that blocks become chained together to create a permanent, unalterable record of all transactions which have been written to the blockchain since its inception. Transactions contain small programs, known as scripts, embedded into their inputs and outputs, which specify how and by whom the outputs of the transactions can be accessed. In order for a transaction to be written to the blockchain, it should be validated by the first node that receives the transaction and if the transaction is validated, the node relays it to the other nodes in the network; adds a new block built by a miner; and mines the new block, i.e., adds it to the public ledger of past transactions.

Cryptocurrencies are bought, loaned, staked, yield farmed, sold, and traded for other cryptocurrencies, goods, services, and/or for fiat (traditional government) currencies. Blockchain technology is the basis upon which cryptocurrencies are secure. Because the data is spread across a network it is inherently public, but by being decentralized it is generally not susceptible to single point security breaches. Typical cryptocurrencies include BITCOIN®, LITECOIN®, ETHEREUM®, RIPPLE®, STELLAR®, and the like. Cryptocurrencies, like stocks, can be bought, sold, and traded on exchanges, such as BINANCE®, GDAX®, and MKRAKEN®. As used herein, cryptocurrencies can include stablecoins which are tokens backed by fixed assets.

Cryptocurrencies can be stored using commercial software platforms that are termed “crypto wallets.” There are a variety of different commercial versions of the crypto wallet, and each have their own benefits. Typical crypto wallets include COINBASE®, LEDGER®, METAMASK®, ELECTRUM®, MYCLEIUM®, and EXODUS®, among others and are essentially programs that hold one's crypto assets and provide the user with a password or key to access their currency. Crypto wallets come in different forms, for example, LEDGER® is a hardware wallet, like a USB stick, while COINBASE® is a web/mobile app. Hardware wallets are considered less risky but have a certain loss of functionality since one can't access their digital currency unless they are in physical possession of their wallet. Additionally, hardware wallets risk loss or destruction and if they are lost, cryptocurrency may also be lost. By contrast, digital wallets are easier to use and not susceptible to being physically lost, but since they reside on-line, they are potentially more susceptible to hacking, corruption and theft. Crypto wallets provide the software “key” to unlocking one's cryptocurrency that resides in the blockchain. If a user loses his private password/key, seed phrase, or crypto wallet, he may never be able to recover his assets.

Tokens, in terms of blockchain transactions, are identifiers for another asset that may be a real-world asset or a digital asset. The “token” can be a fungible token or a non-fungible token. Fungible tokens are tokens that can be exchanged for other tokens or the same type or value, while non-fungible tokens are indivisible and represent a unique item. Fungible tokens can be divided into smaller pieces and are therefore transferrable as a fraction. Cryptocurrency is a form of fungible token.

NFT refers to a token having a unique set of characteristics belonging only to that digital item. Those unique characteristics can be used to certify ownership of that unique digital item, such as digital art, GIFs, music, or video game items. NFTs are not dividable and can only be transferred as a single unit. NFTs are subject to validatable proof of authenticity, are not interchangeable and have a real-world value. Physical art is valuable because one can reliably prove ownership in the piece and its originality. People can make copies of art but only one person can be in possession of the original. NFTs provide the same ownership rights to digital assets allowing individuals to buy, sell, trade, and create value in digital items.

NFTs can be created on the blockchain and can represent either tangible or intangible items. NFTs can include any unique digital asset and therefore have the potential to include almost anything that can be represented digitally, like, art, music, photography, music (audio content), videography, video game contents, digital trading cards/coins, videographic history, including sports clips, memes, social media, including the first tweet, domain names, virtual fashion, virtual real estate, entitlements, including tickets or subscriptions, and even digital pets. NFTs by their nature may be indivisible, while cryptocurrency, also created on the blockchain, is a currency and therefore generally divisible and fungible.

While cryptocurrency and NFTs are currently held and traded as forms of currency, they are currently considered a form of property rather than a form of currency. As cryptocurrency continues to develop, governments could classify them as one or more of a currency, a commodity, a property, a security, or some other type of financial instrument. Each classification includes some unique challenges when transferred. Regardless of the form it takes, going forward, digital assets will make-up larger and larger portions of an individuals' wealth and estate. Efficient methods for holding (accounts/trusts), allocating (naming trust recipients or heirs) and transferring those assets in a manner akin to the way money and other physical assets are transferred now, are needed. Unlike physical assets, digital assets require additional steps including added security, validation of those assets, and collection of keys or passwords prior to transfer of those assets, for example, upon someone's death. Furthermore, while more and more estates can include digital assets, many people remain uncomfortable with cryptocurrency and NFTs and likely won't be in possession of accounts or crypto wallets that will allow them to receive and hold the digital assets. Like any other property that is acquired during someone's life, if it isn't appropriately passed on to one's heirs or assigns, it can be easily lost.

As with the transfer of physical money, both cryptocurrency and NFTs can run the risk that once they are transferred, they are unrecoverable. For at least those reasons, the methods and systems as described herein allow a digital asset owner to securely allocate digital assets for disposition as they see fit during their lifetime and/or upon their death and know that the system will i) validate the occurrence of the life event denominated by the asset owner or the asset owner's death, ii) authenticate and/or collect the asset owner's digital assets, and iii) transfer those assets to appropriate accounts in accordance with the owner's wishes with minimal risk associated with asset loss or improper transfer.

### SUMMARY

Various embodiments of the present disclosure provide methods and systems for creating a Digital Directive for securely transferring cryptocurrency and NFTs.

In one embodiment, a method for allocating cryptocurrency and/or NFTs to a beneficiary subsequent to a denominated life-event is provided. The method includes creating, by a user, a Digital Directive account, the Digital Directive account allowing the user to direct the dispensation of a CPS file, validating, by the processor, the identity of the user using Live-ID, initiating, by the user, a CPS file which stores confidential, private or secret information, designating, by the user, recovery instructions including naming individuals authorized to recreate and access the CPS file, validating, by the processor, the named individuals using Live-ID, receiving, by the processor, a request to regenerate the CPS file, validating, by the processor, the identity of the individuals authorized to recreate and access the CPS file, and regenerating and displaying the CPS file to the individuals, as appropriate.

In another embodiment, a computer readable medium is disclosed. The one non-transitory computer readable medium is configured to store instruction that when executed by at least one processor included in a computing device, cause the computing device to perform a method comprising creating, by a user, a Digital Directive account, the Digital Directive account allowing the user to direct the dispensation of a CPS file, validating, by the processor, the identity of the user using Live-ID, initiating, by the user, a CPS file which stores confidential, private or secret information, designating, by the user, recovery instructions including naming individuals authorized to recreate and access the CPS file, validating, by the processor, the named individuals using Live-ID, receiving, by the processor, a request to regenerate the CPS file, validating, by the processor, the identity of the individuals authorized to recreate and access the CPS file, and regenerating and displaying the CPS file to the individuals, as appropriate.

### BRIEF DESCRIPTION OF THE FIGURES

For a more complete understanding of example embodiments of the present technology, reference is now made to the following descriptions taken in connection with the accompanying drawings in which:

FIG. 1 is an example flow diagram of a method of allocating and transferring assets in accordance with an example embodiment.

FIG. 2 is an illustration of an environment where embodiments can be practiced.

FIG. 3 is a block diagram of an electronic device in accordance with embodiment as described.

FIG. 4 is a block diagram of one example of a server of FIG. 2.

FIG. 5 is a flow diagram of a method of creating a Digital Directive in accordance with embodiments of the invention.

FIG. 6 is a flow diagram of disbursement of assets in accordance with a Digital Directive of FIG. 5.

FIG. 7 is a flow diagram of a method of creating a Digital Directive with custody in accordance with embodiments of the invention.

FIG. 8 is a flow diagram of disbursement of assets in accordance with a Digital Directive of FIG. 7.

FIG. 9 is a flow diagram of a method of creating a Digital Directive with Custodial wallets in accordance with embodiments of the invention.

FIG. 10 is a flow diagram of disbursement of assets in accordance with a Digital Directive of FIG. 9.

FIG. 11 is a flow diagram of another disbursement of assets in accordance with a Digital Directive.

FIG. 12 is a flow diagram of a disbursement of assets held by an exchange in accordance with embodiments of the invention.

### DETAILED DESCRIPTION

In the following description, for purposes of explanation, numerous specific details are set forth to provide a thorough understanding of the present disclosure. It will be apparent, however, to one skilled in the art that the present disclosure can be practiced without these specific details. In other instances, systems and methods are shown in block diagram form only to avoid obscuring the present disclosure.

Reference in this specification to “one embodiment” or “an example embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to the details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure. In addition, the sequence of operations of the method need not be necessarily executed in the same order as they are presented. Further, one or more operations may be grouped together and performed in the form of a single step, or one operation may have several sub-steps that may be performed in parallel or in sequential manner.

In the following discussion and in the claims, the terms “including,” “comprising,” and “is” are used in an open-ended fashion, and thus should be interpreted to mean “including, but not limited to.”

The various example embodiments described in the present disclosure provide methods and systems for securely allocating, storing, authenticating, collecting, and/or transferring digital assets, in one embodiment cryptocurrency and NFTs, after a life-event of an owner. While various digital assets will be discussed individually, as will become clear, the methods and systems as described can be used to create and control any digital asset that can be stored, secured, and authenticated prior to transfer.

For ease of understanding, the systems and methods as described herein may be collectively referred to as a “dispensation” system for digital assets. The systems and method provide a structure through which digital assets can be allocated by an owner for a future dispensation upon a definable event. The systems are constructed to provide an interactive platform for the digit asset owner allowing them to allocate their assets and define life events when they desire distribution of their digital assets. The system includes delineated processes for independent validation of both the existence of the asset and the occurrence of the life event. Once the asset and life event are validated, the system provides a method for the digital assets to be transferred into holding accounts which can be frozen allowing any third-party claims to the assets to be realized. Finally, the system provides for creating of appropriate accounts/wallets for beneficiaries so that they may receive their digital property easily and efficiently.

As used herein “blockchain” includes all forms of computer-based distributed ledgers. While the methods and systems as described herein refer to the transfer of assets from a single blockchain, it should be recognized that cross-chains transactions are fully contemplated within this disclosure. Cross-chain transaction refers to movement of an asset, for example, an NFT, between different block chain ledger systems. For the systems and methods as described, digital assets will be transferred to digital wallets on the same blockchain platform, but may, when desired be transferred between different blockchain platforms using any art recognized or after developed platform for transferring digital assets between blockchains. For fungible assets, the asset will be closed or “sold” in the first platform and opened or “repurchased” in the second platform. In one embodiment, the beneficiary may select the platform in which they wish to receive a fungible digital asset and the various fungible digital assets may be converted to the beneficiaries' platform of choice.

As used herein “digital asset” refers to any digital material that can be stored and transmitted electronically through a computer of other digital device and which includes associated ownership or use rights. Digital assets include anything which is tokenizable. Digital assets as defined herein include, without limitation, digital currency, for example, bank or brokerage accounts including any after developed digital currencies issued by governments or institutions tasked with the issuance of global currency; stablecoins; cryptocurrency, including BITCOIN®, SOLANA®, CARDANO®, POLKADOT®, BITCOIN® Cash, LITECOIN®, DOGECOIN®, ETHEREUM®, RIPPLE®, BINANCE® COIN, TETHER®, POLYGON®, etc.; tokens, including initial coin offerings, security tokens; NFTs, like, art, music, photography, videography, video game contents, digital trading cards/coins, videographic history, including sports clips, memes, social media, including the first tweet, domain names, virtual fashion, virtual real estate, entitlements, including tickets or subscriptions, and even digital pets; social media and on-line accounts, including, for example, TikTok, Facebook, Instagram, Apple Music; digital files, including images, audio files, video files, documents; and secret information, including for example, passcode, keys and other confidential information. The number of different cryptocurrencies currently available is over 18,000 and the number of currencies and people investing in them is expected to grow.

The digital information can take any form suitable for digital storage with the nature of the information dependent upon the purpose of the digital asset. Digital assets may be stored locally on hard drives, desktops, flash, and thumb drives, and the like or may be stored in the cloud, for example on a blockchain, an encrypted server, a social media platform, and any other after developed storage method.

The systems and methods as described can be used to transfer digital assets regardless of the manner in which they are held/encrypted as long as the digital asset owner provides the appropriate key to access the digital asset. For purposes of this disclosure, the term “tokenize” as it relates to a process during encryption is not the same as “Non-fungible token.” One manner of making a digital asset more secure is to “tokenize” the asset, i.e., substitute a token for the original and then further encrypt the token so that a third-party would have to access both the encrypted token and then the tokenized asset. This is different from the meaning of a non-fungible token, which, as described above is a digital asset which is unique. NFTs as described herein may be subjected to encryption or tokenization or both. Further, as the systems and methods as described either collect or secure with the user, the necessary transfer “keys” for all assets, the systems and methods as described can be used to transfer assets that might be subject to any after developed security methods.

As used herein “digital wallet” refers to any software platform that holds one or more digital assets. The term “wallet” is well understood with reference to Cryptocurrency and NFTs, but it is defined herein to refer to any account that the digital asset owner uses to store his one or more digital assets. For example, if the digital assets are business documents that are stored as pdf documents in an appropriate platform, for purposes of the instant disclosure, the business documents would be stored in a “digital wallet” appropriate for those documents and would be transferred to another “digital wallet” appropriate to receive those digital assets. In the case when digital assets are found on a third-party platform, e.g., an Instagram® or TikTok® account, the beneficiary will not receive the digital assets in a wallet but will only receive the right to access the information in the account which may include setting up an account in the name of the beneficiary and transferring any content thereto.

The term “digital wallet” is also used to refer to the software platform and accounts that the Asset Custodian uses to hold a digital asset and the beneficiary accounts that are used to receive the transfer of a digital asset.

As used herein, the information needed to access the digital asset will be termed a “key.” Keys can include any form or authentication including knowledge factors, possession factors, or inherence factors, and may be single or multi-factor. Examples of keys, include, passwords, phone numbers, social security numbers, biometrics, including fingerprints voice recognition, facial recognition, or eye scans, digital certificates, decryption programs, seed phrases, private keys, token-based authentication (a digital token received based upon entry or credentials).

While the discussion herein is primarily directed to the transfer of currency and NFTs, the methods and systems as described can be used to allocate and transfer any other digital asset in which the user possesses ownership including for example, social media accounts, medical information, estate information, personal, professional, confidential, and/or business information, and the like. Applicant has previously filed applications directed to the handling and disposition of these types of other digital assets and the systems and method as discussed in those applications for handling digital information and creating digital estates can be used, as appropriate, in the instant systems and methods.

By way of example, U.S. patent application Ser. No. 16/186,445 to Chintala, filed Nov. 9, 2018, is incorporated by reference in its entirety and describes methods and systems for handling digital content in a digital locker. The embodiments include an automated digital asset management that provides enhanced execution of documents, the ability to provide secure storage and retrieval of documents within a digital locker and easy digital asset disbursement.

U.S. patent application Ser. No. 16/695,182 to A. Chintala, filed Nov. 26, 2019, is incorporated by reference in its entirety and describes methods and systems for handling digital content in a digital locker. The embodiments disclosed therein include processes and system for the secure storage of digital files including the shredding of the files.

U.S. patent application Ser. No. 16/898,298 to A. Chintala, filed Jun. 10, 2020, is incorporated by reference in its entirety and describes embodiments directed to methods and systems for establishing digital estate plans for online accounts and personalized messages stored in digital lockers (digital lockers as described are equivalent to digital vaults, binders or other references used by the current applicant and that relate to a portioned storage for any digital asset).

U.S. patent application Ser. No. 17/542,649 to A. Chintala, filed Dec. 6, 2021, is incorporated by reference in its entirety and describes embodiments directed to methods and systems for creating online vaults to secure digital information and protocols to carry out the release of the digital information in accordance with the instructions of the digital vault owner.

Each of these applications include methods and systems for creating and handling digital asset disposition and estate documents including creation, execution, and notarization of such documents. By way of example, the prior applications describe a live-sign application whereby a user can sign authorization documents in front of a witness and notary, virtually, using a server facilitated platform. The live-sign application can record the authorization session and save it to appropriately to be accessed later. Likewise, the prior applications describe systems and methods whereby the user can assign account designees and define the type and manner of participation in the user's account. Further, the prior applications describe systems and methods for initiating and validating a disbursement request, setting up a disbursement authorization event and dispersing the content of a digital locker. The skilled artisan would understand the cross application of the previously described methods and systems to the instant description.

As described therein, a user may access a tool/platform (e.g. a live-sign application), on their respective devices, facilitated by the server. In a non-limiting example, the live-sign application may be a web application or a mobile application. As discussed, devices may access the live-sign platform by installing an application using application stores associated with Apple IOS™, Android™ OS, Google Chrome OS, Symbian OS®, Windows Mobile® OS, Windows Phone, BlackBerry® OS, Embedded Linux, web OS, Palm OS® or Palm Web OS™, and the like. Alternatively, the live-sign application may be installed as a stand-alone application on a stand-alone device.

As discussed in the prior application, when the user requests an authorization session the system can create the live-sign event and send requests to participants, such as, the user, guardian, custodian, or anyone else associated with the digital asset account. In one embodiment, the system or the individual initiating the live-sign event verifies the identities of the participants (the witness, the user, the guardians, beneficiaries, custodians and the like). Verification can occur in a variety of ways including, but not limited to, identity cards, facial recognition, biometric fingerprints, voice and retinal scan. Upon completion, the user or the system may save a copy of the authorization session or its recording in a secure location, for example, a server and/or a database for future reference. An ultra security file storage module of the server may be used to encrypt the authorization session by any known encryption method of by creating one or more slices before saving it in the server and/or the database.

Any authorized documents, authorization events or authorization recordings can be made available for viewing in the live-sign platform, (also referred to at times as ‘a live-sign portal’). Additionally, or alternatively, at operation, any existing document pertaining to the authorization document can also be uploaded to the live-sign portal. During operation, existing documents are retrieved by processing and conversion so as to be appended, as appropriate, to an authorization document created by the user. The authorization event details include authorization session information and access credentials for the user and any other participants. The authorization session information may include venue details, date and time of the authorization event for the user and/or the one or more participants particularly if the participants are participating remotely or at different times. The access credentials may include log in information such as user name, access code, web link, and the like for virtual participation in the authorization event. Electronic reminders (e-reminders or reminders) for the authorization event are automatically sent by the server to the participants.

The live-sign process can be offered as a standalone service to other users who may or may not be part of the digital locker system. In one embodiment, the live-sign platform can be configured to be a stand-alone video notary process.

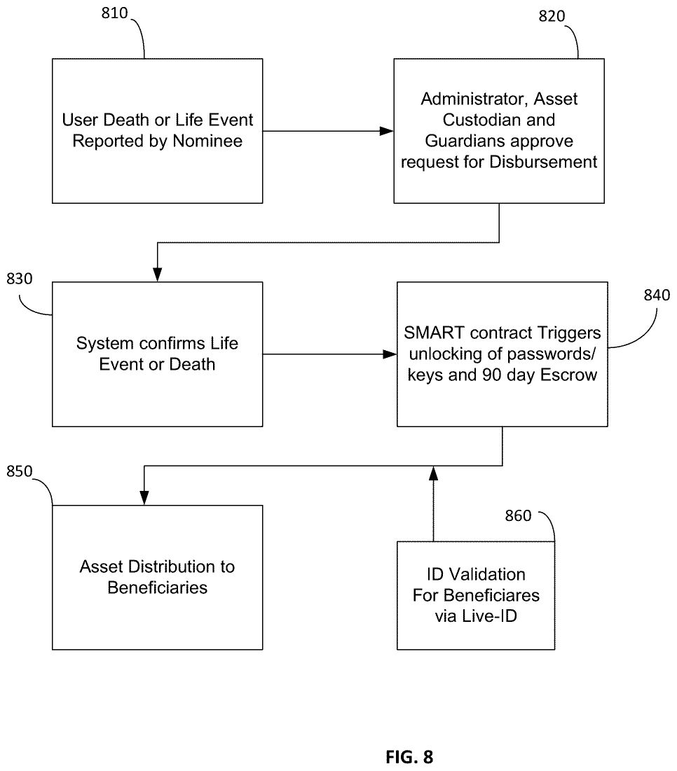

In FIG. 8A of the prior application, one example of the live-sign platform is described. The user interface can display participants and participant information for a live-sign session. The display information is described to include one or more of the name and designation of the participant, an image of the participant, a symbol indicating that the participant has logged into the live-sign platform, an icon indicating device type (smart phone), and/or geographical location of the participant in terms of geographical co-ordinates, location name and time zone.

In the embodiment described, the user interface can include a block that displays a checklist of procedures to be completed during the live-sign event to confirm that all legal requirements as may be accounted for (generally or jurisdictionally) are completed during the live-sign event. The checklist in the example presented in the prior filed application includes procedures such as, logging in of the notary, witnesses, and the testator, identity verification of all participants, document verification (authorization documents), testator signature, witness signature and the notary signature. In the example as described, the user can check a box corresponding to a step or procedure when that procedure in the checklist is completed. As will be understood, the sequence of operations need not to be necessarily executed in the same order or as they are presented in this diagram and/or multiple operations may be grouped together and performed in form of a single step.

As used herein, “life-event” means any event in the life of a digital asset owner that can be denominated for the purpose of creating a pre-condition for the transfer of the owner's digital asset. Life-events, without limitation include, births, deaths, birthdays, anniversaries, graduations, jobs, promotions, payments, annuities, and even an arbitrary date, e.g., Jan. 1, 2050. If the denominated life-event doesn't include a trust and is a simple gift, for example, then the asset transfer can occur upon the happening and validation of the life-event. For example, if the life-event is a birthday and the Conveyance contract is to transfer a sum certain of cryptocurrency on that date, then once the birthday is verified, the asset transfer can occur without limitation, i.e., an escrow period. If the Conveyance contract includes a trust or any precondition that requires approval, the digital asset owner will have to nominate himself, a guardian, or a trustee to be responsible for any decisions that must be made prior to disbursement. In another example, the Conveyance contract can be set up to make student loan or rent payments from a digital asset account. In one embodiment, the digital asset owner creates a Conveyance contract that is a SMART contract that executes a transfer of a payment amount on a date each month to an account associated with the recipient or to an escrow account that can be used to transfer the asset to the account of the recipient. In either embodiment, the Conveyance contract would be set up as a SMART contract thereby resulting in automatic execution.

As used herein “fractionable asset” refers to any assets than can be subdivided for distribution to multiple parties. Money is a fractionable asset that can easily be distributed to any number of parties as mere percentages. As used herein “unfractionable asset” refers to any asset that cannot be subdivided and distributed and must either be distributed as a singular object or as a class of objects. Many NFTs will be unfractionable, and distribution will occur in the same manner as currently done for real property. The distribution of digital assets that are “unfractionable” may be carried out on a percentage basis only if the Conveyance contract requires sale of the assets in advance of the distribution or if the asset is to be held be two partial owners (e.g., 50% ownership shares) with only one having physical control of the asset. Unfractionable assets can be distributed individually or by class. When assets are distributed by class, they may be grouped in any reasonable way the owner of the information desires, for example, all audio files to individual X and all video files to individual Y.

To the extent a digital asset owner wishes to “fraction” an otherwise “unfractionable” assets, the digital asset owner will have to create individual “unfractionable” assets that can then be distributed to an individual or via a class. For example, if an asset owner wants all his “Memes” to be given to recipient A and all his photographs to go to recipient B, then he will have to create individual accounts holding the various assets that can be transferred in accordance with his desires. According to one embodiment, the system will provide prompts to the digital asset owner if/when they attempt to transfer a “unfractionable” asset to more than a single owner. In one embodiment, the prompt may ask the owner to specify a single owner. According to another embodiment, the prompt may ask the owner if he wishes to liquidate the assets to enable fractional ownership. According to yet another embodiment, the prompt may specify that if the owner wishes to move forward with fractional ownership of an unfractionable asset he must designate a single recipient having physical control of the asset.

According to one embodiment, the digital assets may be sold or converted to fiat currency prior to distribution at the desire of either the digital asset owner, specified via the contract, or the desire of the beneficiary by submitting a request that the assets be sold/converted prior to their distribution. In the event digital assets are converted to fiat currency, the assets may be transferred into accounts newly created for the beneficiary or may be transferred to accounts as existing third parties, such as banks, brokerage houses and the like.

As used herein “digital asset owner,” “asset owner,” “owner,” and “user” are used interchangeably and refer to the individual who owns a digital asset and who uses the system and methods as described herein to provide dispensation of one or more digital asset.

As used herein, “beneficiary” or “recipient” refers to an individual designated to receive one or more digital assets.

As used herein, “guardian” refers to a person who is designated by the digital asset owner and who can participate in authorizing the key or password distribution which allows digital assets to be transferred. A guardian may or may not be a beneficiary. In one embodiment, the digital asset owner does not appoint a guardian for the asset/account. In another embodiment, the digital asset owner appoints a guardian for the asset/account. In yet another embodiment, the digital asset owner appoints a plurality of guardians for the asset/account. When one or more guardians are appointed by the digital asset owner, the digital asset owner may specify whether all guardians need to agree before asset/key distribution. In one embodiment, the digital asset owner may specify that a majority of guardians must agree. In another embodiment, the digital asset owner may specify that a quorum of guardians must agree. In yet another embodiment, the digital asset owner may specify that in the event of disagreement, one guardian's decision may prevail. As will be readily understood, the manner of using the guardian to safeguard asset distribution may differ for each digital asset.

As used herein “account designee” refers to any individual whom the user associates with a particular account for any purpose. As will be understood, account designees include beneficiaries, recipients, guardians, administrators, trustees, and the like. Account designees can also include individuals that do not fit an above-described account function but are requested by the user for any purpose. By way of example, if the digital asset is an art-based asset, the user could request that the asset be authenticated by an art dealer. The specified art dealer would be, for those purposes, an account designee. Functions of a designee differ and are defined by the user at the time of creating of the Conveyance contract and designation. For example, a designee can be a guardian assigned to confirm the occurrence of a life-event or precondition, to trustee to monitor the welfare of the user, a custodial partner to hold one or more keys, act as a trustee, etc.

As used herein “escrow” refers to a time period over which an independent holder receives assets that have been validated and are ready for transfer. In some embodiments as described, the escrow holder may act as an executor and will transfer the assets into the accounts of the beneficiary.

As used herein “Asset Custodian” refers to the system mechanism or individual who can hold and manage the user's digital assets. The Asset Custodian participates in the Conveyance contract process and collects the keys for the various assets from the user or the guardian upon verification of the life event. The Asset Custodian holds and manages the digital assets and transfers those assets from the user's wallet(s) to escrow.

As used herein, “Custody Partner” refers to the third-party custodian who holds and releases key information provided by the digital asset owner. The custody partner participates in the Conveyance contract process and collects the keys for the various assets from the user at the time the contract is entered into. The Custody Partner holds and manages the user's keys and transfers those keys to the Executor or Trustee upon their request and approval by the account guardians. Once the keys have been transferred, the Executor or Trustee can enable the digital wallet and transfer the digital assets to an escrow account or the beneficiaries.

As used herein “trustee” refers to the individual nominated by the digital asset owner to make decisions for asset distribution if the asset is the subject of a trust or the contract preconditions require interpretation. According to one embodiment, the digital asset owner may be nomination himself as the trustee on a particular account.

As used herein “Administrator” refers to anyone who upgrades, installs, or configures application software or hardware; creates or manages permissions or user accounts; performs security monitoring and updates, installing, and configuring application software and computer hardware; troubleshoots or provides technical support; and maintains networks or network files. The system Administrator may take certain actions within the administration of the executed contract including, for example, prepare and finalize contracts, issue contract certificates, set up and approve notaries, set up and approve custodians, approve ID validation, confirm life-event, set up or create digital asset accounts and wallets, provide notification to beneficiaries, provide notification to exchanges, approve release of keys, approve release of assets, make a determination to forego an escrow period, determine whether to entry contract completion into the blockchain,

As used herein “Administrative Executor” and “Administrative Trustee” refers to another embodiment wherein the contract may not have a live digital asset owner, a viable account designee or a viable guardian to handle execution of the Conveyance contract. In this embodiment, the Administrator can act as the Executor or Trustee if their position is established by contract with the digital asset user. In the event that the account has no viable designee, beneficiary or guardian and there is no provision for an Administrative Executor or Trustee, the property will generally pass to heirs via the unclaimed property statutes associated in the appropriate jurisdictions where the digital asset owner resided.

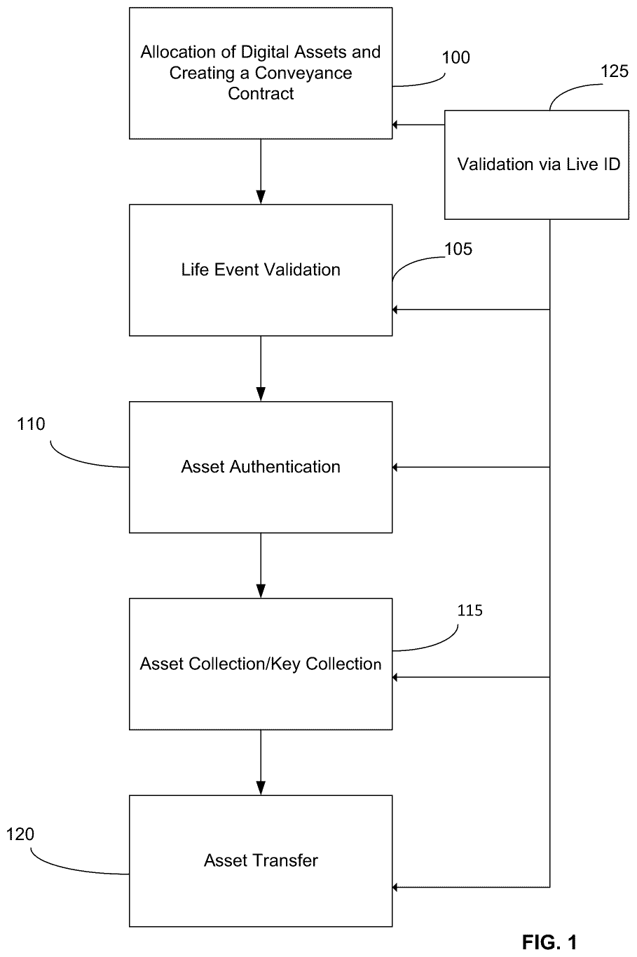

FIG. 1 provides a generalized overview for the system and methods as described herein. In one embodiment as seen in FIG. 1, the system as described creates a platform where a user can specify the digital assets that they possess and create a Conveyance contract identifying those assets and defining how those assets are to be transferred or disposed of upon the occurrence of a particular life-event 100, for example, the death of the user.

As used herein “Conveyance” contract refers to the instrument that the user creates to define his digital assets for transfer and the recipients or beneficiaries that are to receive those digital assets. During the creation of the Conveyance contract, the user will also create and select guardians, account designees, custodial partners and address all administrative questions associated with account creation and the desired transfer of the digital asset. The issue of unfractionable assets may be addressed during formation of the Conveyance contract or may occur as a later step in the process.

The Conveyance contract may be a SMART contract that runs on a blockchain or may be a non-blockchain based application. In one embodiment, the Conveyance contract can run as a centralized solution, for example, the contract can be created and stored on a system server. According to another embodiment, the Conveyance contract can be fully decentralized, for example, a SMART contract that is created and modified on the blockchain and stored, for example on an interplanetary file system (ipfs). In yet another embodiment, the Conveyance contract can be created using a hybrid system pulling some characteristics from each of the centralized and decentralized systems. By way of example, a hybrid system might include parallel posting to both a system server and the blockchain or creation and storage on a central server with final authentication and storage on the blockchain. As will be readily apparent to the skilled artisan, a variety of hybrid system can be created to balance the desired security versus the time and system costs associated with decentralized solutions. According to yet another embodiment, the Conveyance contract may be created on a shadow system. A shadow system is a decentralized system that may be stored, for example, on a local server, but which mimics a centralized system from which one or more digital assets may originate, for example, COINBASE.

SMART contracts are software programs that are generally stored on a blockchain and that run when a predetermined set of conditions is met. SMART contracts are generally used to execute agreements based upon a series of if/then conditions. A SMART contract is a machine executable program which comprises rules that can process inputs in order to produce results, which can then cause actions to be performed dependent upon those results. In respect of commercial transactions, for example, these may involve the transfer of property rights and/or assets. Such assets may include real property, personal property including both tangible and intangible property), digital assets such as software, for example, or any other type of asset. Upon occurrence of the condition and its verification, the action part of the agreement is carried out, e.g., send a notification, transfer an asset, etc. SMART contracts reduce time loss and execute agreements without the need for an intermediary. SMART contracts are generally effective, accurate and secure making them a good option when handling digital assets.

If the Conveyance contract acts as a will, the event will be the death of the user. However, many other types of Conveyance contracts can be created to cause transfer of digital assets. For example, a gift contract could be created where the user transfers a digital asset as a gift to the recipient on the event of their birthday. Likewise, Conveyance contracts could be used to create trusts, for example, a cryptocurrency account could be created in trust for a child to be received on their 21st birthday.

As seen in the embodiment of FIG. 1, once the Conveyance contract exists, execution of the contract will only occur after validation of the event 105. As described herein, the event is a precondition that has to be specified with sufficient detail to allow validation or the user would be required to provide for a designee tasked with determining whether the precondition is satisfied to ensure that no asset is transferred incorrectly or prematurely since some digital assets cannot be resecured once transferred. Event validation and methods for conducting it are discussed at length below.

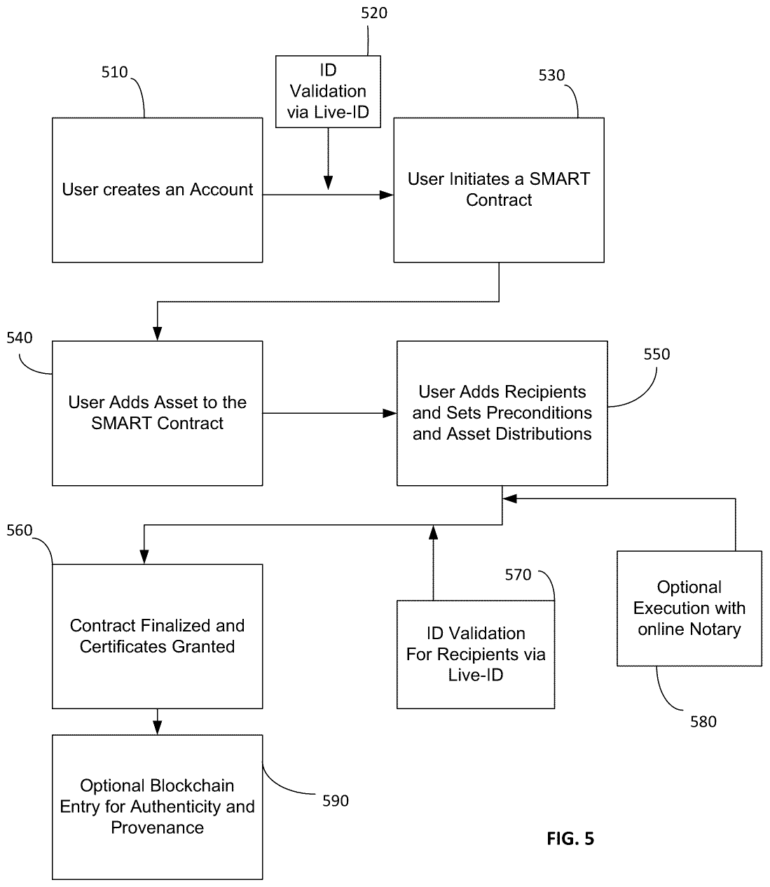

The embodiment in FIG. 1 illustrates that once the asset has been validated 110, then the artifacts surrounding the asset must be collected or physical control of the asset has to be achieved before the asset can be transferred. The system as described herein, uses a number of steps to secure and prepare the asset for transfer. Such methods are discussed more fully in FIGS. 5-10.

In the system and methods as described digital assets may be “self-held” or may be “Custodian-held.” As used herein “self-held” assets refer to digital assets over which the user has full control of the digital asset and retains the assets and their passwords, private keys, seed phrases and any other pass keys. Upon the death of the user, the passwords or pass keys will have to be provided to the Executor or Trustee in order for the asset to be transferred. Assets which are described as “Custodian-held” are assets where an Asset Custodian holds the digital assets and passwords, private keys, seed phrases or any other pass keys and upon the death of the user, the Asset Custodian can transfer the assets to the Executor or Trustee without the beneficiaries having to locate the information needed to transfer the assets. Assets that are Custodian-held are far less likely to be lost upon the death of the owner.

For assets that are self-held, the assets must be validated, and the keys or passwords must be released from the Custody Partner to the Executor of the estate of the owner upon the validation of a life event 115. For Custodian-held assets upon validation of the life event, the process of transferring the assets from the Asset Custodian to an escrow account is begun. Once the asset keys and passwords have all been collected 115, the process of transferring the assets is carried out 120.

The asset transfer process as described herein provides a period of time when the digital asset is held and controlled so that any party that wishes to contest the transfer, collect taxes, or carry out any other administrative request can do so without the assets being prematurely transferred. As the asset is unlikely to be resecured after transfer, heirs to digital assets, in particular, are susceptible to loss if the asset is moved prior to resolution of all issues surrounding the asset.

In one embodiment, the user enters the system and creates an account or logs into an existing account. The user's identity is validated and the user begins the process of creating a Conveyance contract. In this embodiment, the user begins by defining the digital asset or account on a digital asset exchange that the user wishes to transfer upon his death. As will be self-evident, this embodiment could apply equally to another denominated life event. Once the digital asset is identified, in this embodiment, the user then creates one or more beneficiaries that he wishes to receive the digital asset and their percentage distribution. In this embodiment, the beneficiaries are contacted, validated, and made a party to the Conveyance contract. Once the beneficiaries are established, the user defines the guardians to be associated with this digital asset. In this embodiment, the user can specify any number of guardians and then specify the number of guardians that must approve before the digital asset may be transferred. The use of account guardians in this way can protect an asset from improper transfer while still allowing transfer when all guardians don't agree. In this embodiment, the guardians are validated and also made party to the Conveyance contract. If the asset is on an exchange, for example, the Asset Custodian would continue to hold the digital asset. If the digital asset is self-held, the user in this embodiment would also select a Custody partner. The Custody partner would be validated and upon execution of the Conveyance contract, the user would provide the Custody Partner with the account keys. The user would then complete execution of the Conveyance contract. As will be understood by the skilled artisan any order of denotation of the beneficiaries, guardians and Custody partners to the contract can be used.

In this embodiment, when the user dies and the user's death has been confirmed, the guardians would be contacted and asked to approve release of the asset. If the required guardians approve the transfer, then the digital asset will be transferred from the Asset Custodian to the Executor or escrow for distribution to the beneficiaries. If the asset is self-held, the Custody partner will release the account keys to the Executor or Trustee so that the digital asset can be transferred to the beneficiaries or Executor.

In the embodiment of FIG. 1, each of the steps in the authentication and validation process have the ability to be carried out using the Live-ID security 125 as described herein. In this embodiment, if the user chooses to engage Live-ID security, then each of the designees associated with the user's account would have to be verified and validated at each step of the process to assure that the individuals who are validating the life event, the assets and the associated keys are the appropriate individuals. While any art recognized security measures can be used, or multi-factor authentication can be used, the inclusion of Live-ID provides additional layers of security that are particular benefit when dealing with valuable digital assets.

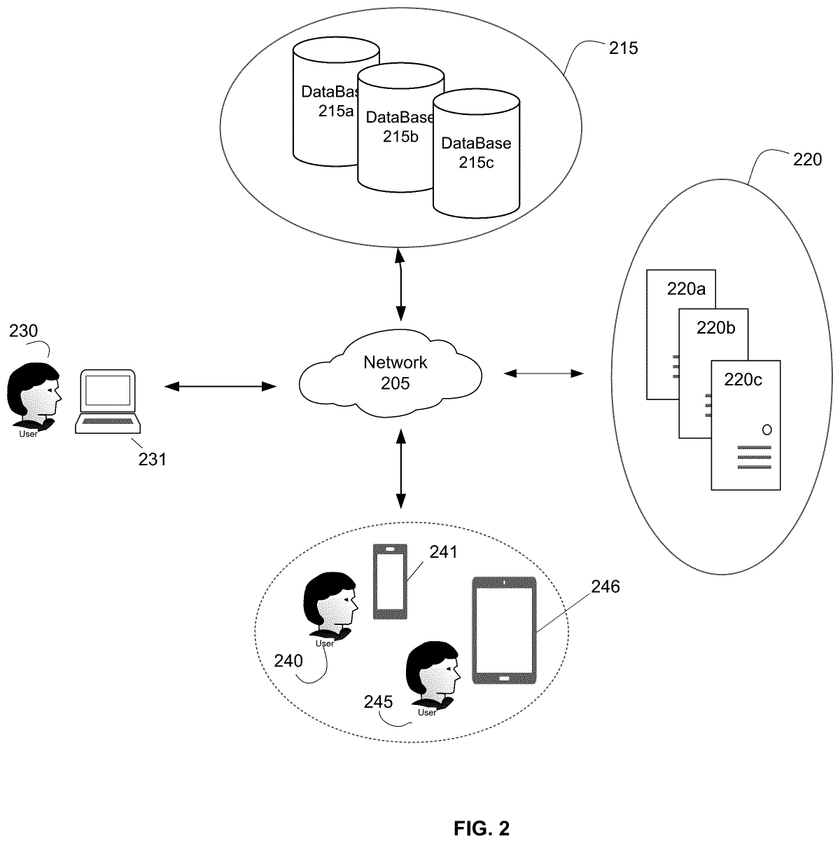

FIG. 2 illustrates a typical computing environment in which the methods as described herein can operate. A user 230 interacts with a network 205 via a computer or smart device 231. The network may include servers 220 and databases (215a, 215b, 215c referred to herein as 215) that are commonly located or that are distributed and decentralized. In at least one example embodiment, the server (220a, 220b, 220c referred to herein as 220) can be a single computing system in which a local drive or a shared drive may be stored. The network 205 may be centralized or decentralized and may comprise a plurality of sub-networks that may offer a direct communication between the entities or may offer indirect communication between the entities. Examples of the network 205 include, but are not limited to, the Internet, local area network (LAN), wide area network (WAN), wireless, wired, and the like.

In connection with the various embodiments, the user 230, and third parties 240 and 245 whose roles can vary depending on the embodiment, may each have one or more communication devices for communicating among themselves or with the network. In an example, the user 230 has a device 231, the third parties 240 and 245 have devices 241 and 246, respectively. Examples of the devices 231, 241, and 246 may take the form of any portable electronic device (e.g., laptops, smartphones and tablets, radio receivers, wireless communicators) having cellular and/or WIFI communication capabilities. For instance, the devices 231, 241, and 246 may be equipped with subscriber identity module (SIM) or Removable User Identity Module (R-UIM) to enable cellular communication.

FIG. 2 depicts a cloud computing environment in accordance with the present disclosure. It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service.

On-demand self-service: a cloud consumer can unilaterally provision computing capabilities, such as server time and network storage, as needed automatically without requiring human interaction with the service's provider.

Broad network access: capabilities are available over a network (e.g., one or more network(s) 205, as depicted in FIG. 2) and accessed through standard mechanisms that promote use by heterogeneous thin or thick client platforms (e.g., mobile phones, laptops, and personal data assistants (PDAs)).

Resource pooling: the provider's computing resources are pooled to serve multiple consumers using a multi-tenant model, with different physical and virtual resources dynamically assigned and reassigned according to demand. There is a sense of location independence in that the consumer may have no control or knowledge over the exact location of the provided resources but can be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Software as a Service (Saas): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including the network(s) 205, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including the network(s) 205, operating systems, or storage, but has control over the deployed applications and possibly application hosting environment configurations.

Infrastructure as a Service (IaaS): the capability provided to the consumer is to provision processing, storage, the network(s) 205, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Database as a Service (DBaaS): a cloud-based approach to the storage and management of structured data that delivers database functionality similar to what is found in relational database management systems (RDBMSes) such as, for example, SQL Server, MySQL, and Oracle. DBaaS provides a flexible, scalable, on-demand platform oriented toward self-service and database management, particularly in terms of provisioning a business' own environment. DBaaS systems can include monitoring engines to track performance and usage, error monitoring, and data analysis engines.

Private cloud: the cloud infrastructure is operated solely for an organization. It can be managed by the organization or a third party and can exist on-premises or off-premises.

Community cloud: the cloud infrastructure may be shared by several organizations and supports a specific community that has shared concerns (e.g., mission, security requirements, policy, and compliance considerations). It can be managed by the organizations or a third party either locally or remotely.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds). All of the above-described cloud system configurations could be used to carry out the methods and systems as described and can be selected by a user as appropriate.

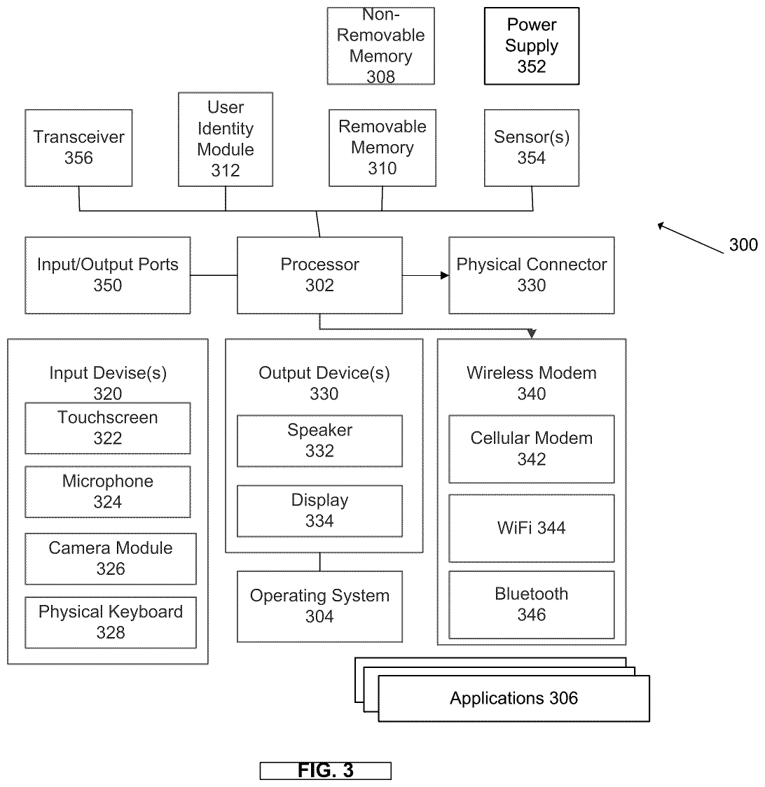

FIG. 3 is a simplified block diagram of an electronic device 300 capable of implementing the various embodiments of the present disclosure. The electronic device 300 may be an example of the system in FIG. 2. In an embodiment, the dispensation process as described herein can be facilitated by the digital asset owner using the platform installed in the electronic device 300. It should be understood that the electronic device 300 as illustrated and hereinafter described is merely illustrative of one type of device and should not be taken to limit the scope of the embodiments. As such, it should be appreciated that at least some of the components described below in connection with that the electronic device 300 may be optional and thus, in an example embodiment may include more, less, or different components than those described in connection with the example embodiment of the FIG. 3. As such, among other examples, the electronic device 300 could be any type of mobile electronic device and may be embodied in any of the electronic devices, for example, cellular phones, tablet computers, laptops, mobile computers, personal digital assistants (PDAs), mobile televisions, mobile digital assistants, or any combination of the aforementioned other types of communication or multimedia devices.

The illustrated electronic device 300 includes a controller or a processor 302 (e.g., a signal processor, microprocessor, ASIC, or other control and processing logic circuitry) for performing such tasks as signal coding, data processing, image processing, input/output processing, power control, and/or other functions. An operating system 304 control the allocation and usage of the components of the electronic device 300 and support for one or more applications programs (e.g., the Digital Directive application or the live-sign application) that implements one or more of the innovative features described herein. The applications 306 may include common mobile computing applications (e.g., telephone applications, email applications, calendars, contact managers, web browsers, messaging applications such as USSD messaging or SMS messaging or SIMTool Kit (STK) application) or any other computing application. One or more applications for controlling the dispensation system are configured to be in operative communication with other applications for example, through the OS or using API Calls, for sending/receiving notifications, such as check-in notifications.

The illustrated electronic device 300 includes one or more memory components, for example, a non-removable memory 308 and/or a removable memory 310. The non-removable memory 308 and/or the removable memory 310 may be collectively known as database in an embodiment. The non-removable memory 308 can include RAM, ROM, flash memory, a hard disk, or other well-known memory storage technologies. The removable memory 310 can include flash memory, smart cards, or a Subscriber Identity Module (SIM). The one or more memory components can be used for storing data and/or code for running the operating system 304 and the applications. The electronic device 300 may further include a user identity module (UIM) 312. The UIM 312 may be a memory device having a processor built in. The UIM 312 may include, for example, a subscriber identity module (SIM), a universal integrated circuit card (UICC), a universal subscriber identity module (USIM), a removable user identity module (R-UIM), or any other smart card. The UIM 312 typically stores information elements related to a mobile subscriber. The UIM 312 in form of the SIM card is well known in Global System for Mobile Communications (GSM) communication systems, Code Division Multiple Access (CDMA) systems, or with third-generation (3G) wireless communication protocols such as Universal Mobile Telecommunications System (UMTS), CDMA9000, wideband CDMA (WCDMA) and time division-synchronous CDMA (TD-SCDMA), or with fourth-generation (4G) wireless communication protocols such as LTE (Long-Term Evolution) or fifth generation wireless signals transmitted through large numbers of small cell stations at a spectrum between 30 and 300 gigahertz (Ghz) at high speeds (5G).

The electronic device 300 can support one or more input devices 320 and one or more output devices 330. Examples of the input devices 320 may include, but are not limited to, a touch screen/a display screen 322 (e.g., capable of capturing finger tap inputs, finger gesture inputs, multi-finger tap inputs, multi-finger gesture inputs, or keystroke inputs from a virtual keyboard or keypad), a microphone 324 (e.g., capable of capturing voice input), a camera module 326 (e.g., capable of capturing still picture images and/or video images), a physical keyboard 328 or any other after developed input device.

Examples of the output devices 330 may include but are not limited to a speaker 332 and a display 334. Other possible output devices can include piezoelectric or other haptic output devices or any other after developed output device. Some devices can serve more than one input/output function. For example, the touch screen 322 and the display 334 can be combined into a single input/output device.

A wireless modem 340 can be coupled to one or more antennas (not shown in the FIG. 3) and can support two-way communications between the processor 302 and external devices, as is well understood in the art. The wireless modem 340 is shown generically and can include, for example, a cellular modem 342 for communicating at long range with the mobile communication network, a Wi-Fi compatible modem 344 for communicating at short range with an external Bluetooth-equipped device or a local wireless data network or router, and/or a Bluetooth-compatible modem 346. The wireless modem 340 is typically configured for communication with one or more cellular networks, such as a GSM network for data and voice communications within a single cellular network, between cellular networks, or between the electronic device 300 and a public switched telephone network (PSTN).

The electronic device 300 can further include one or more input/output ports 350, a power supply 352, one or more sensors 354 for example, an accelerometer, a gyroscope, a compass, or an infrared proximity sensor for detecting the orientation or motion of the electronic device 300, a transceiver 356 (for wirelessly transmitting analog or digital signals) and/or a physical connector 360, which can be a USB port, IEEE 1294 (FireWire) port, and/or RS-232 port. The illustrated components are not required or all-inclusive, as any of the components shown can be deleted and other components can be added.

The disclosed systems and methods with reference to FIGS. 1 to 10, or one or more operations of the flow diagrams (FIGS. 5 to 10) may be implemented using software including computer-executable instructions stored on one or more computer-readable media (e.g., non-transitory computer-readable media, such as one or more optical media discs, volatile memory components (e.g., DRAM or SRAM), or non-volatile memory or storage components (e.g., hard drives or solid-state non-volatile memory components, such as Flash memory components) and executed on a computer (e.g., any suitable computer, such as a laptop computer, net book, Web book, tablet computing device, smart phone, or other mobile computing device).

Such software may be executed, for example, on a single local computer or in a network environment (e.g., via the Internet, a wide-area network, a local-area network, a remote web-based server, a client-server network (such as a cloud computing network), or other such network) using one or more network computers. Additionally, any of the intermediate or final data created and used during implementation of the disclosed methods or systems may also be stored on one or more computer-readable media (e.g., non-transitory computer-readable media) and are considered to be within the scope of the disclosed technology. Furthermore, any of the software-based embodiments may be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

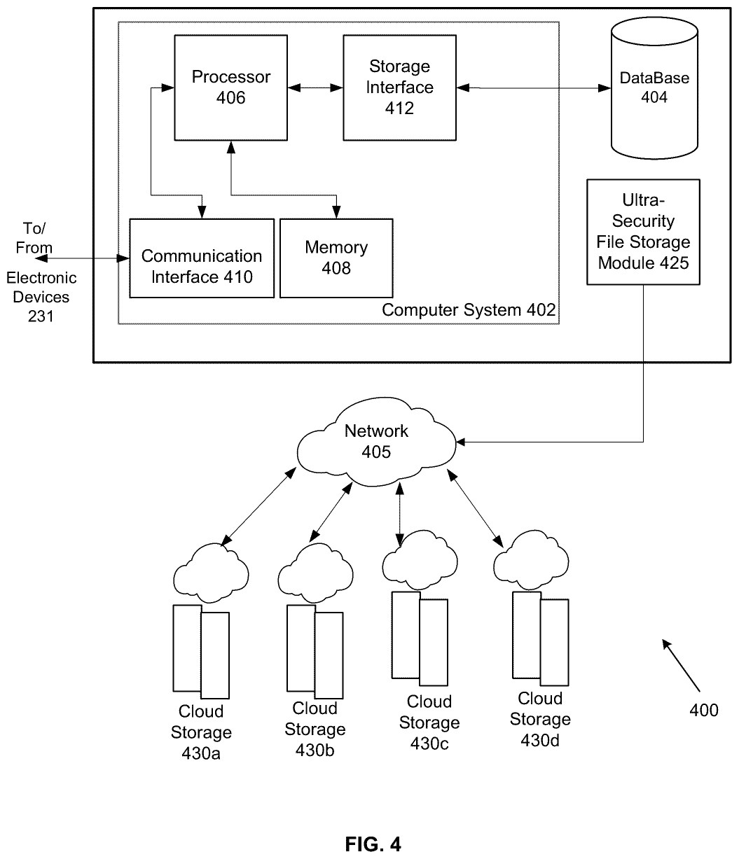

FIG. 4 is a block diagram that illustrates a server 400, which may be an example of the network 205, in accordance with an embodiment of the present disclosure. The server 400 includes a computer system 402 and one or more databases, as a database 404. The server 400 also includes an ultra-security file storage module 425. The storage module 425 can be a randomization logic that stores executable instructions to slice the encrypted or unencrypted files and store the slices on a local system 426, a shared system 428 or a network of distributed cloud storage systems such as cloud storage systems 430a, 430b, 430c and 430d connected through a network 935. Examples of the network 435 include Cellular network, Wide Area Network (WAN), wireless network, Internet, and any network employing any known communication technologies. In a non-limiting example, the sliced content (e.g., by splitting the content in many small parts) along with its metadata may be stored using block chain technology.

The computer system 402 includes a processor 406 for executing instructions. Instructions may be stored in, for example, but not limited to, a memory 408. The processor 406 may include one or more processing units (e.g., in a multi-core configuration). The processor 406 is operatively coupled to a communication interface 410 such that the computer system 402 is capable of communicating with a remote device such as an electronic device 231. Some examples of the electronic device 231 may include but are not limited to the electronic devices discussed in relation to FIG. 3.

As shown in FIG. 4, The processor 406 may also be operatively coupled to the database 404. The database 404 is any computer-operated hardware suitable for storing and/or retrieving data. The database 404 may include multiple storage units such as hard disks and/or solid-state disks in a redundant array of inexpensive disks (RAID) configuration. The database 404 may include, but not limited to, a storage area network (SAN) and/or a network attached storage (NAS) system.

In some embodiments, the database 404 is integrated within the computer system 402. For example, the computer system 402 may include one or more hard disk drives as the database 404. In other embodiments, the database 404 is external to the computer system 402 and may be accessed by the computer system 402 using a storage interface 412. The storage interface 412 is any component capable of providing the processor 406 with access to the database 404. The storage interface 412 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 406 with access to the database 404.

The memory 408 is a storage device embodied as one or more volatile memory devices, one or more non-volatile memory devices, and/or a combination of one or more volatile memory devices and non-volatile memory devices, for storing micro-contents information and instructions. The memory 408 may be embodied as magnetic storage devices (such as hard disk drives, floppy disks, magnetic tapes, etc.), optical magnetic storage devices (e.g., magneto-optical disks), CD-ROM (compact disc read only memory), CD-R (compact disc recordable), CD-R/W (compact disc rewritable), DVD (Digital Versatile Disc), BD (Blu-ray® Disc), and semiconductor memories (such as mask ROM, PROM (programmable ROM), EPROM (erasable PROM), flash ROM, RAM (random access memory), etc.,) or any other after developed storage method.

The digital asset dispensation system and methods as described are accessed by the digital asset owner via an on-line account that the user creates. As seen in FIG. 5, the digital asset owner can create a Digital Directive which can direct the dispensation of the owner's digital assets in accordance with his wishes. Once the user creates an account 510, the identification of the user must be validated 520. Since the systems and methods as described are concerned with high value objects and are all carried out on-line, the systems include security measures to assure that the users can be verified at the time the account is created and again when any life event occurs. Identification can be carried out using any art recognized method for authentication. Appropriate methods include knowledge factors, possession factors, or inherence factors, and may be single or multi-factor. Examples passwords, phone numbers, social security numbers, biometrics, including fingerprints voice recognition, facial recognition, or eye scans, digital certificates, token-based authentication (a digital token received based upon entry or credentials), or any other after developed authentication method.

In one embodiment, authentication is carried out using a combination of features associated with the live-sign platform discussed above and the multi-factor authentication and token-based authentication discussed immediately infra. In this embodiment, enrollment and recovery of information that has been stored in the system, for example passkeys and cryptokeys, will be slightly different depending upon who is decrypting and using the information. In the first embodiment, the user may wish to store information that he plans to retrieve himself later, whether it be a passkey, a cryptokey, an NFT or other confidential or sensitive information. In this embodiment, the user is creating and recovering his own information.

In this embodiment, the user logs in and creates a file that will hold his confidential/private/secret information (herein after referred to as the “CPS file.)” Typical multi-factor authentication may be used, for example, the user may be required to enter as password, private device key or a public key. The user may also be asked at this point if he wishes this information be subject to “live-sign” or “Live-ID.” If the information is going to be subject to Live-ID, then the user can select Live-ID verification which is a stronger form of account protection. As will become evident, even if Live-ID is not used, the system generally still includes three levels of protection (that will be more fully discussed below) to reduce or eliminate threats from third parties. With Live-ID applied to the account, it will be very difficult for any third party to access or inappropriately recover the information stored in the CPS file.

Live-ID verification involves first confirming that the user is an actual person and not a machine to prevent hacking. Once the individual is verified to be an actual person, then the user will be subject to biometric identification, for example, facial recognition using one or more stored or accepted images, for example from a government identification. The user's identity may be verified using any biometric marker or combination of biometric markers, including fingerprints, voice recognition, facial recognition, or eye scans. As would be apparent to the skilled artisan, the biometric markers could be replaced by one or digital certificates or token-based authentication methods, if desired. The LIVE-ID verification process would also confirm that the person accessing the account is the same person that set up the account. This may be done, for example, by comparing the user's image to a stored image from when the account was created. Alternatively, the individual may be confirmed to be the account owner using any combination of multi-factor authentication.

Even if the file is not going to be subjected to Live-ID verification, the CPS file once created, can be encrypted using any art recognized or after developed encryption algorithm or the sharding and storage method as described herein. The sharded or encrypted file is then stored until such time as the user wishes to recover the information and requests that the file be regenerated.

When the user requests regeneration of the CPS file, the user will have to log in and enter his system password and go through multi-factor authentication. If Live-ID is being used, the user will have to proceed through Live-ID verification before he can request that the CPS file be regenerated. If Live-ID is not being used at the time or recovery, the user may be identified using any art recognized and accepted methods, for example, the system may send a temporary JWT token or use another tokenization method that results in appropriate verification by the system that that the user has the appropriate access. In one embodiment, the system may generate one or more temporary tokens that may be held by the system and then sent to the user and must be matched at one or more points in the recovery process to enhance tokenized security.

Once the system confirms the identity of the user and that the user has the right to recover the CPS file, the system then retrieves the shards and regenerates the CPS file or decrypts the CPS file and electronically transfers it to the user. In one embodiment, the decrypted information will only be displayed to the user if it is received on an authorized device. As will be readily understood, secure techniques for preserving, storing, decrypting and transmitting information are rapidly evolving. The systems and methods as described can be carried out using the most up to date security without changing the unique and beneficial characteristics of the systems as described.

The security and methods, as describe for creating and recovering CPS files will vary depending upon how the user has set up the file and whether the recovery is by the user or another third party authorized to recover the CPS files upon a denominated life event. In one embodiment, the system may send our period user requests to confirm that the stored key validity has not changed over time and needs to be updated. Such system reminders and the associated protection of those reminders would be consistent with the security selected by the user while setting up the account.

In another embodiment, the user wishes to store information that he plans to have a beneficiary receive after his death. In this embodiment, the user is creating the account and the CPS file, but won't be the one to recover and use the information later. In this embodiment, the user logs in and creates a file that will hold his confidential/private/secret information. Again, multi-factor authentication will be used, for example, the user will be required to enter one or more of a password, private device key or a public key. The user will again be asked whether he wishes to use the Live-ID feature. If the information is going to be subject to Live-ID, then the user selects Live-ID verification which is a stronger form of account protection. If the user fails to select Live-ID then more standard multi-level, multi-factor protection will be applied as discussed above.

Once the file is created and encrypted it is again stored until such time as the third-party beneficiary (or other authorized third party, e.g., an executor, asset custodian) recover the information and requests that the file be regenerated. If the user engages Live-ID validation then the system will require any third-party, regardless of authorization or relationship, to undergo the Live-ID process to verify their identity before the regeneration of any file or the release of any information.

When the beneficiary(s) requests regeneration of the CPS file, the beneficiary and any guardians or other safeguards selected by the user will have to log into the system and be verified. If Live-ID is being used, each participant will have to confirm Live-ID verification the requested CPS file be regenerated. If Live-ID is not being used at the time or recovery, the participants may be identified using any art recognized and accepted methods, for example, the system may send a temporary JWT token or use another tokenization method that results in appropriate verification by the system that that the user has the appropriate access. Again, the system may generate one or more temporary tokens that may be held by the system and then sent to the user and must be matched at one or more points in the recovery process to enhance tokenized security.

Once the system confirms the identity of the user and that the user has the right to recover the CPS file, the system then retrieves the shards and regenerates the CPS file or decrypts the CPS file and electronically transfers it to the user. In one embodiment, the decrypted information will only be displayed to the user if it is received on an authorized device. As will be readily understood, secure techniques for preserving, storing, decrypting and transmitting information are rapidly evolving. The systems and methods as described can be carried out using the most up to date security without changing the unique and beneficial characteristics of the systems as described.

Once the user creates an account, he can initiate a Conveyance contract 530 which can take the form of a will, trust, gift, real estate contract, or any other contract specifying disposition of digital assets. The user then adds the assets he wishes to distribute to the Conveyance contract 540 and sets up the preconditions for asset distribution and the intended recipients/beneficiaries 550. Once the recipients are designated, the system again validates the identity of the recipients 570 using the same techniques discussed above for the user. Once the recipients have been verified, the user can also specify any additional account designees, including an Executor or Trustee. These account designees will be validated and can become party to the Conveyance contract. Once all account designees are added, the user can then sign the contract using an optional online notary 580. Once the contract has been executed, it is finalized, and certificates are granted 560. Finally, the Conveyance contract may be entered into the Blockchain for authentication and to establish provenance of the Conveyance contract in future.

During asset allocation, the system distinguishes between fractionable and non-fractionable assets. The system can use any appropriate method for distinguishing between fractionable and non-fractionable assets. By way of example, in one embodiment, the system can flag any digital asset that is indicated to be split by multiple recipients. In this embodiment, the system can generate a query to the user requiring them to designate the asset as fractionable or non-fractionable. If the asset is non-fractionable, then the user will not be able to proceed until they complete additional queries indicating how they expect that asset to be divided. In one embodiment, in the event of multiple recipients of a non-fractionable asset, the system may require that the user designate the percentages of ownership along with who shall have physical control of the asset. In another embodiment, the system allows the user to require the asset be sold prior to distribution. In still another embodiment, the system can query the user to either provide a designation by item or by class of items to a particular recipient. For example, all NFTs can go to Bob, or all social media accounts can go to Alice or all gaming artifacts can go Joe. In yet another embodiment, the system may only query fractionability of digital assets for certain classes of assets. In this embodiment, the system would only query the user regarding fractionability if the asset is something other than a currency-based asset. In another embodiment, the user may want to liquidate the assts and enable the fractional disbursement of all assets to the beneficiaries.

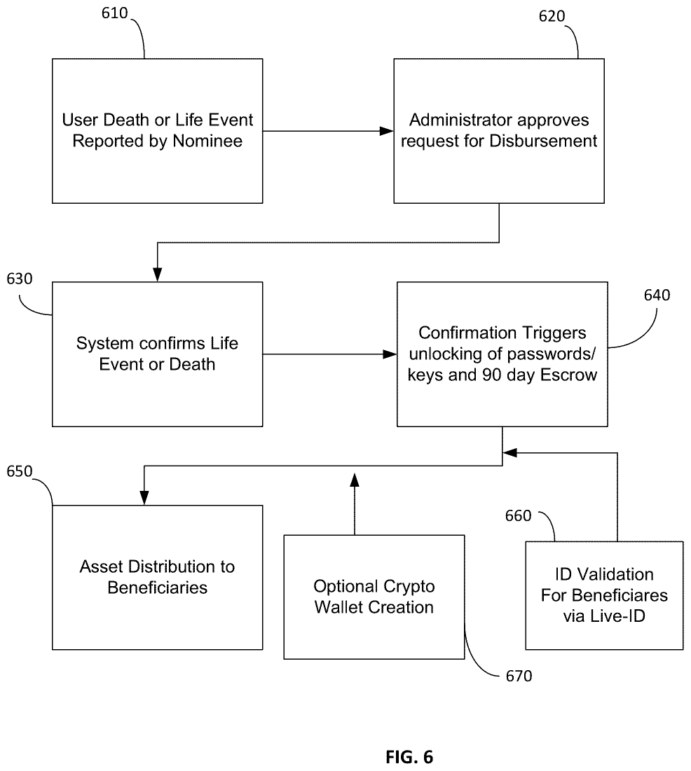

When a life event specified by the digital asset owner occurs, the notification will generally come from the asset owner, the asset beneficiary or one or more of the guardians for the user's account. As seen in FIG. 6, once the life event has been reported 610, the system recognizes that a request for distribution has been received 620. The system then independently confirms the life event 630. The system may independently confirm the life event by any appropriate method. For example, if the life-event is a date, the system may need do nothing more than confirm the date on the calendar. If the life-event is, for example, a birthday, the system may require the recipient to provide a copy of their driver's license or birth certificate. If the life event is a death, the system may request a copy of the death certificate from the beneficiary or from the state in which the user died or the system may request confirmation of death from a third party whose business it is to confirm death certificates. As can be seen from these examples, the confirmation of the occurrence of the life-event can differ significantly depending upon the nature of the life-event. In all instances, the system may use one or more account designees as a basis for confirming the happening of the life-event. Account designees can include, the user, a designee of the user, guardians, trustees, and the like. This confirmation triggers the system to unlock the digital asset keys and passwords and starts the escrow window 640.

The escrow period can be of any duration, but typical escrow periods will be from 30 to 90 days. During the escrow period any death notifications can be made and any creditors or non-beneficiary third parties can make a claim against the estate. In one embodiment, for certain life-events, for example, where the asset owner is still alive, a limited or no escrow may be used.

Once all third-party challenges have resolved and the escrow period has elapsed, the system again verifies the identity of the recipients via Live-ID 660 prior to transfer of the digital assets. In one embodiment, digital wallets, i.e., appropriate receiving accounts, are creating during the creation of the Conveyance contract by the user. In another embodiment, recipient account creation is not undertaken until the time of transfer of the digital assets. In one embodiment, if the recipient already has his own accounts or crypto wallets, the assets may be transferred to a beneficiaries' existing accounts directly 650, or in another embodiment, the recipient may request that digital wallets be created by the system for the purposes of receiving the asset distribution.

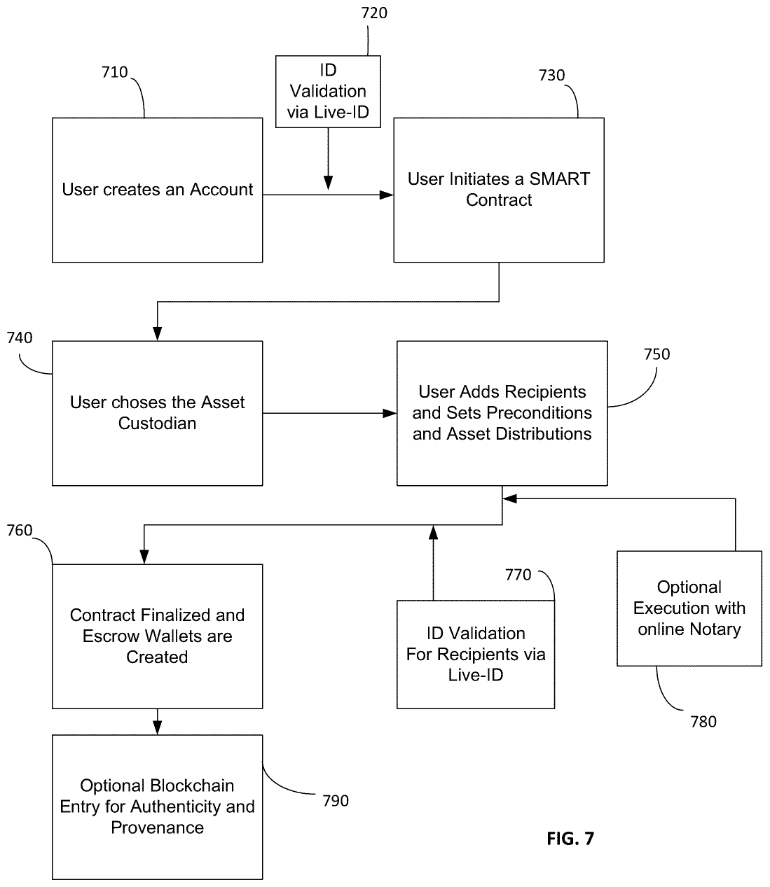

As seen in FIG. 7, the user may create his Digital Directive so that his digital asset keys are Custodian-held. In this embodiment, the user creates an account 710, after which his identity is verified 720. As seen in FIG. 7, the user initiates his Conveyance contract 730 but, in this embodiment, he chooses an Asset Custodian 740 who, like the user, will hold the digital asset keys so that the contract may be executed without the user having to present his key(s). The chosen Asset Custodian participates in the generation of the Conveyance contract. Then as discussed above, the user sets up his recipients and specifies his preconditions 750 and the recipients are verified via Live-ID 770. The user then executes the Conveyance contract 760, with or without notarization 780, and Blockchain authentication 790. In this embodiment, the digital assets remain in the custody of the user and the keys are communicated to and/or regenerated and stored with the chosen Asset Custodian.

As with FIG. 6 above, once a life event specified by the digital asset owner occurs, the notification will serve as a request for distribution. As seen in FIG. 8, once the life event has been reported 810, the system recognizes that a request for distribution has been received 820, however in this instance, the request will generally have to be approved by the system, the custody partner and a designee associated with the account. The system then independently confirms the life event 830 which again triggers the system to unlock the digital asset keys and passwords and starts the escrow window 840. Again, once all third-party challenges have resolved and the escrow period has elapsed, the system again verifies via Live-ID the identity of the recipients 860 prior to transfer of the digital assets. If the recipient has his own accounts or crypto wallets, the assets can be transferred directly 850, or the recipient may request that crypto wallets be created by the system for the purposes of receiving the asset distribution.

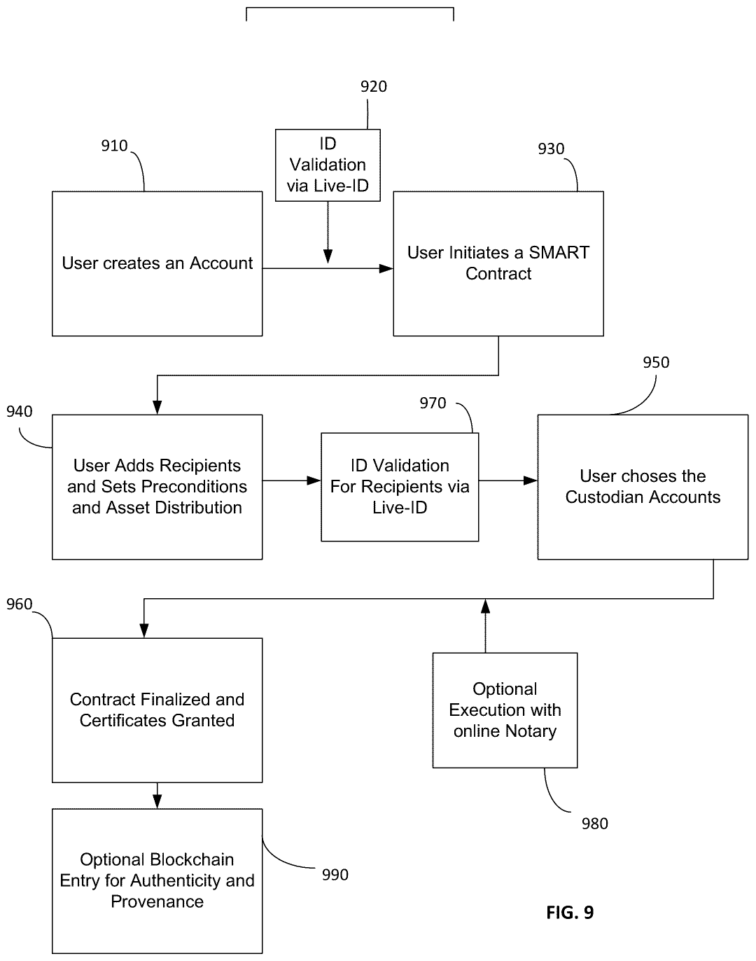

As seen in FIG. 9, the user may create his Digital Directive so that his assets are held in custodial accounts, essentially placing his assets into holding accounts until which time he either transfers the assets back to himself or the contracted precondition occurs. In this embodiment the user creates an account 910, after which his identity is verified 920. As seen in FIG. 9, the user initiates his Conveyance contract 930, sets up his recipients and specifies his preconditions 950 and the recipients are verified via Live-ID 970. In this embodiment, the user choses the custodial accounts that will hold his digital assets. 950. In this embodiment, digital accounts or crypto wallets are created for each of the assets or recipients. In this embodiment, the assets will be held in the custodial account until which time the precondition or life-event happens, or the user revokes the contract and moves the digital asset. Digital assets held in custodial accounts will have their own keys which will be held by the Asset Custodian. Generally, the keys to custodial accounts would not be held by the user; however, according to one embodiment, the user could also have a copy of the account key. In this embodiment, one would generally expect the user and Asset Custodian to provide in the Conveyance contract how and when each could use their keys. The user then executes the contract 960, with or without notarization 980 and Blockchain authentication 990.

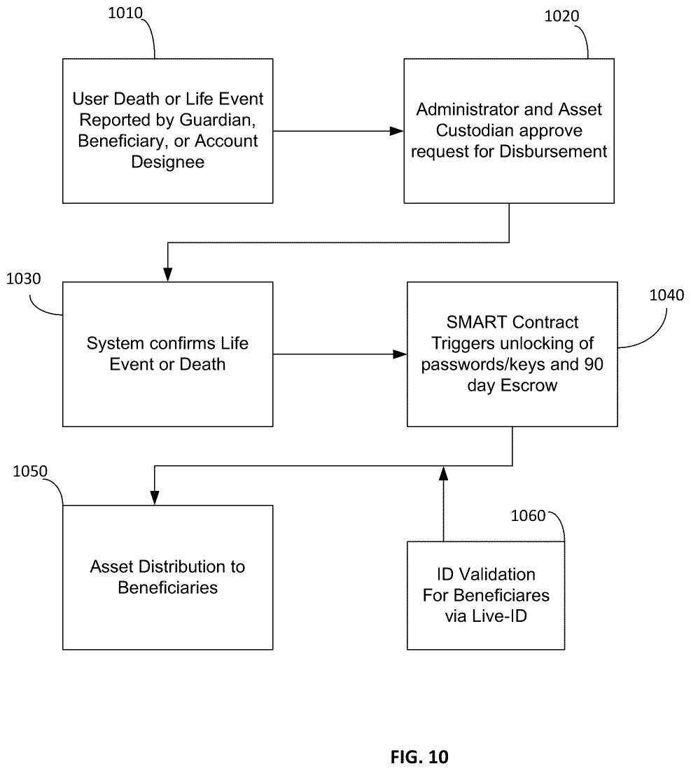

As seen in FIG. 10, once the life event has been reported 1010, the system recognizes that a request for distribution has been received 1020, however in this instance, the request will generally have to be approved by the system and the escrow or custodial account holder. The system then independently confirms the life event 1030 which again triggers the system to unlock the digital asset keys and passwords and starts the escrow window 1040. Again, once all third-party challenges have resolved and the escrow period has elapsed, the system again verifies the identity of the recipients 1060 prior to transfer of the digital assets. If the recipient has his own accounts or crypto wallets, the assets can be transferred directly 1050, or the recipient may request that crypto wallets be created by the system for the purposes of receiving the asset distribution.

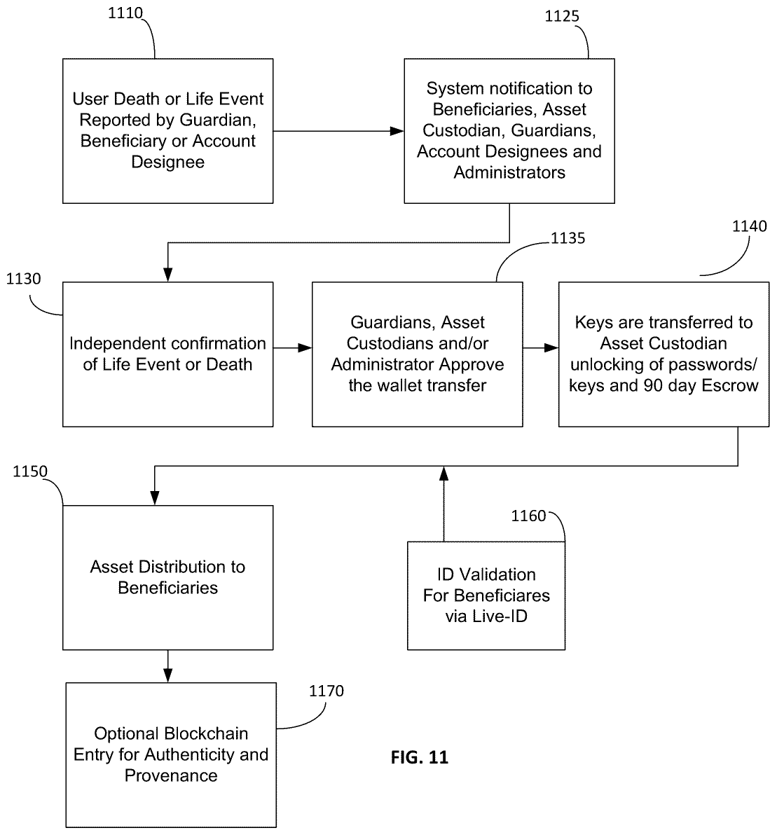

FIG. 11 describes a life event that has been reported by a guardian, beneficiary, or account designee 1110. According to this embodiment, when the life event is reported 1110, the system notifies the remaining beneficiaries, remaining guardians, remaining account designees, along with any asset custodians and the administrator of the occurrence of the life event 1125. The administrators obtain independent confirmation of the life event 1130. Once the life event has been confirmed, the designated individuals that might include one or more guardians, one or more account designees and one or more asset custodians, optionally with the administrator, approve the wallet transfer. The wallet can include any digital asset. Once the wallet transfer is approved 1135, the keys are transferred to the asset custodian who can then unlock the accounts and begin the escrow period 1140. In this embodiment, the wallet may remain with the asset custodian or can be transferred to an escrow account at the desires of and in accordance with the digital asset owners wishes. Again, once all third-party challenges have resolved and the escrow period has elapsed, the system again verifies the identity of the recipients via Live-ID 1160 prior to transfer of the digital assets. If the recipient has his own accounts or crypto wallets, the assets can be transferred directly 1150, or the recipient may request that crypto wallets be created by the system for the purposes of receiving the asset distribution. The system then optionally executes an entry to the Blockchain for authentication and provenance 1170.

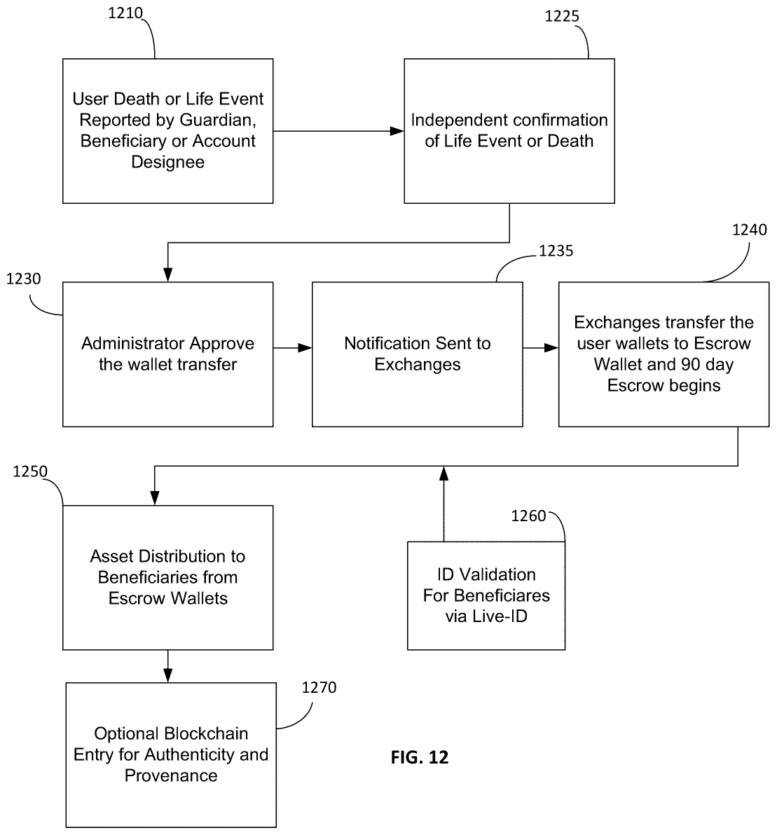

FIG. 12 describes a distribution when the digital asset is held by and third-party account or by an Exchange. In this embodiment, when the life event that has been reported by a guardian, beneficiary, or account designee 1210, the administrators obtain independent confirmation of the life event 1225. Once the life event has been confirmed, the administrator approves the wallet transfer 1230. Again, the wallet can include any type of digital asset that may be held in a third-party account or by an Exchange. Once the wallet transfer is approved 1230, notification is sent to the third party or Exchange 1235 and the Exchange transfers the user's wallet to an escrow account and the escrow period begins 1240. Again, once all third-party challenges have resolved and the escrow period has elapsed, the system again verifies the identity of the recipients via Live-ID 1260 prior to transfer of the digital assets. If the recipient has his own accounts or crypto wallets, the assets can be transferred directly 1250, or the recipient may request that crypto wallets be created by the system for the purposes of receiving the asset distribution. The system then optionally executes an entry to the Blockchain for authentication and provenance 1270.

The methods and systems have been described herein through the lens of the digital asset user creating an account and allocating their own assets for subsequent distribution, however, the methods and systems as described may be used for the collection and distribution of digital assets that have been allocated via a more traditional written will or trust instrument. In this embodiment, the beneficiary or the executor of an estate that contains crypto currency or NFTs can create an account to handle the collection and disposition of the digital assets. As with the methods discussed above, the user, in this case and executor or attorney, creates an account, enters into a Conveyance contract and defines the recipients or beneficiaries to the digital assets. Then, depending upon the choices of the user, the assets and beneficiaries are verified, accounts or crypto wallets are created, and the digital assets may be escrowed and transferred.

These and other variations and modifications will become apparent to those skilled in the art once the above disclosure is fully appreciated. It is intended that the following claims be interpreted to embrace all such variations and modifications.

We claim:

1. A method for storing and regenerating a CPS file comprising:
a) creating, by a user, a Digital Directive account, the Digital Directive account allowing the user to direct the dispensation of a CPS file;
b) validating, by the processor, the identity of the user using Live-ID;
c) initiating, by the user, a CPS file which stores confidential, private or secret information;
d) designating, by the user, recovery instructions including naming individuals authorized to recreate and access the CPS file; and
e) validating, by the processor, the named individuals using Live-ID.

2. The method of claim 1, further comprising
f) receiving, by the processor, a request to regenerate the CPS file;
g) validating, by the processor, the identity of the individuals authorized to recreate and access the CPS file; and
h) regenerating and displaying the CPS file to the individuals, as appropriate.

3. The method of claim 1, further comprising
verifying the user or named individuals via one or more authentication factors prior to Live-ID.

4. The method of claim 3, wherein the authentication factors are chosen from passwords, phone numbers, social security numbers, fingerprints, voice recognition, facial recognition, eye scans, digital certificates, or authentication tokens.

5. The method of claim 1, wherein the CPS file contains one or more keys or passwords.

6. The method of claim 1, wherein Live-ID includes confirmation of the user as a person, the identification of the user based on one or more biometrics, and confirmation that the user is also the individual who created the account.

7. The method of claim 6, wherein the biometric identification is chosen from one or more of fingerprints, voice recognition, facial recognition, or eye scans.

8. The method of claim 6, wherein confirmation of the user identity as the account creator is based upon a stored image.

9. The method of claim 1, further comprising identification of the user based on one or more temporary tokens.

10. The method of claim 9, wherein the temporary token is further stored in the system and matched to the user prior to release and regeneration of the CPS file.

11. A non-transitory computer readable medium configured to store instruction that when executed by at least one processor included in a computing device, cause the computing device to perform a method for storing and regenerating a CPS file comprising:
a) creating, by a user, a Digital Directive account, the Digital Directive account allowing the user to direct the dispensation of a CPS file;
b) validating, by the processor, the identity of the user using Live-ID;
c) initiating, by the user, a CPS file which stores confidential, private or secret information;
d) designating, by the user, recovery instructions including naming individuals authorized to recreate and access the CPS file; and
e) validating, by the processor, the named individuals using Live-ID.

12. The non-transitory computer readable medium of claim 11, causing the computing device to perform a method further comprising
f) receiving, by the processor, a request to regenerate the CPS file;
g) validating, by the processor, the identity of the individuals authorized to recreate and access the CPS file; and
h) regenerating and displaying the CPS file to the individuals, as appropriate.

13. The non-transitory computer readable medium of claim 11, causing the computing device to perform a method further comprising
verifying the user or named individuals via one or more authentication factors prior to Live-ID.

14. The non-transitory computer readable medium of claim 13, wherein the authentication factors are chosen from passwords, phone numbers, social security numbers, fingerprints, voice recognition, facial recognition, eye scans, digital certificates, or authentication tokens.

15. The non-transitory computer readable medium of claim 11, wherein the CPS file contains one or more keys or passwords.

16. The non-transitory computer readable medium of claim 11, wherein Live-ID includes confirmation of the user as a person, the identification of the user based on one or more biometrics, and confirmation that the user is also the individual who created the account.

17. The non-transitory computer readable medium of claim 16, wherein the biometric identification is chosen from one or more of fingerprints, voice recognition, facial recognition, or eye scans.

18. The non-transitory computer readable medium of claim 16, wherein confirmation of the user identity as the account creator is based upon a stored image.

19. The non-transitory computer readable medium of claim 11, causing the computing device to perform a method further comprising identification of the user based on one or more temporary tokens.

20. The non-transitory computer readable medium of claim 19, wherein the temporary token is further stored in the system and matched to the user prior to release and regeneration of the CPS file.
